(19) United States
(12) Patent Application Publication
(10) Pub. No.: US 2008/0096586 A1
(43) Pub. Date: Apr. 24, 2008

(54) Internet Protocol Based Multimedia System (Ims)

(76) Inventors: Rene Bemmer, Klufterstrasse (DE); Matthias Britsch, Steinweg (DE)

Correspondence Address: NORRIS, MCLAUGHLIN & MARCUS, 875 THIRD AVE, 18TH FLOOR, NEW YORK, NY, 10022, US

(21) Appl. No.: 10/532,008

(22) PCT Filed: Oct. 30, 2003
(86) PCT No.: PCT/EP03/12042

§ 371 Date: Nov. 14, 2005

(30) Foreign Application Priority Data
Oct. 31, 2002 (EP) 02024256.6

(51) Int. Cl. H04Q 7/20

(52) U.S. Cl. 455/466

(57) ABSTRACT

The present invention relates to an Internet protocol based multimedia system characterized by combining means for location information with media components during information exchange between a communication center and peripheral units, and a procedure for information exchange using the components of such an Internet protocol based multimedia system.

The present invention relates to an Internet protocol based multimedia system (IMS) used within a mobile communication network. Generally, this invention relates to wireless digital communication systems and methods, and particularly to third generation (3G) networks and to mobile terminals that operate in such networks.

A communication via e-mail and short message service is well known. By using, these communication methods it is not possible for a subscriber to send multimedia messages within a certain range of distance around his own location.

It is the object of the present invention to disclose an Internet protocol based multimedia system and a procedure which provides a subscriber of a mobile communication with enhanced multimedia services.

This object is achieved according to the features of the independent claims.

According to the independent apparatus claim of the present invention an Internet protocol based multimedia system is provided which is characterized by a combination of means for location information with media components during information exchange between a communication center and peripheral units. A procedure for information exchange using the components of such an Internet protocol based multimedia system is described in the independent method claim.

Further embodiments and preferred features of the invention are disclosed in the dependent claims.

The present invention offers to the user a so called Mobile Community Service which is described below. Starting point for service definition was the aim to make use of the unique capabilities of mobile networks in general and unique features provided by IMS to combine them in a new service type. One of the unique capabilities of mobile networks is the availability of providing location information of a subscriber using a mobile terminal. Among mobile networks only IMS based networks allow the exchange of presence information and combination of media components in a session. The presented service exploits all this unique features of IMS based mobile networks.

The service according to the invention gives the subscriber the possibility to advertise his mobile handset for approach of interested people within a certain range around the subscriber's current location by sending them a message of a chosen media type and vice versa, that means receiving a set of chosen media types from people within a certain range.

The service sequence is as follows:

A subscriber decides to become active in the mobile community, subsequently he logs in to the network and gets to the “mobile community” application menu in his terminal device.

There a choice is offered to change the mode to “interested in contact”. By selecting this mode the choice between two modes is offered. He can become active and send his contact data to other users, named hereinafter “advertising” mode or he can decide to go for the inactive mode, not sending but receiving other community members data only, at further called “receiving” mode. Of course both modes can also operate in parallel.

For both possibilities the preferred name and media type can be specified. If the “advertising” mode is chosen, the media type and the special content to be sent can be specified. Also, the region in which the content shall be sent to interested receivers can be specified.

The information content can be a text or a picture message, a video clip or a voice message. All the messages can be either recorded directly by using the handset capabilities or chosen from a set of pre-recorded contents. These contents can be stored on a personal account via a web interface at any time. The stored contents are offered on a selection menu automatically to the subscriber if the “advertising” mode is selected. To avoid the necessity of carrying a high end device that is able to host all applications necessary for recording of content, web access to the Internet is provided to all the users. This gives all the users the possibility to create content at their home PC and store it for later selection via the mobile's menu, where the pre-recorded content or content information (e. g. network data) is shown up automatically when the mobile terminal service module is activated. Content can also be predefined via web access so the mobile has not to deal with the content at all.

The region in which the content shall be distributed can be specified by abstract distribution classes, for example such as “local”, “walking distance” and “city wide”. The distribution class “local” would cover approximately the size of a radio cell and perhaps the neighboring cells, the distribution class “walking distance” would mean within a walking distance of 15 min and the distribution class “city wide” would mean in the borders of the city, but still reachable by public transportation. Other or additional distribution classes, such as “regional” or “national” would be also possible-

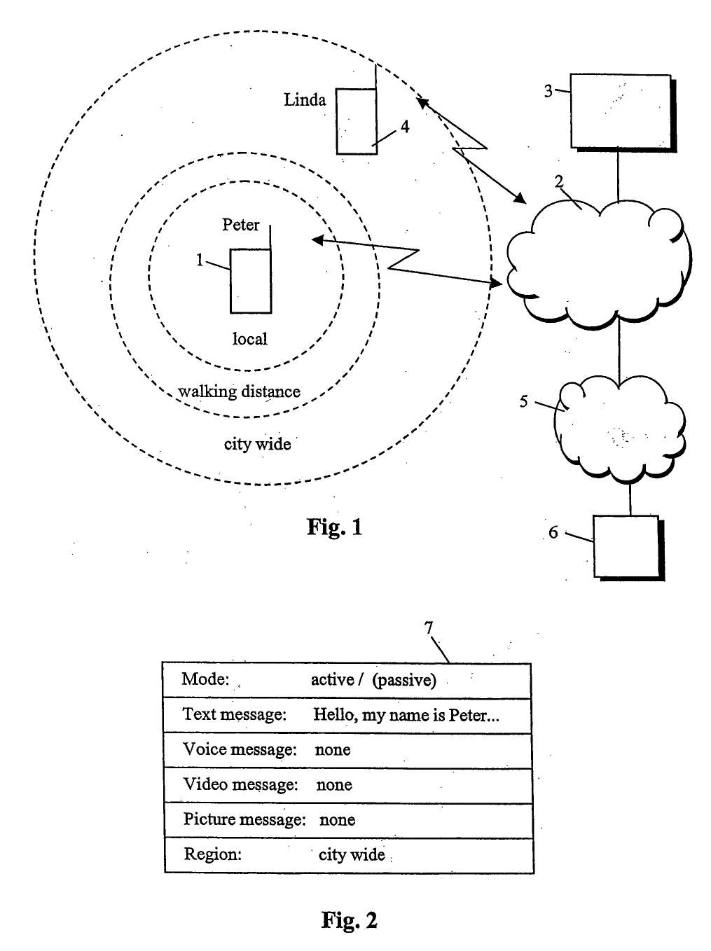

A typical user scenario—described in connection with drawing FIGS. 1 and 2—could look as follows:

Peter, a software consultant was sent to the city to support the customers IT department. In the evening he decides to relax in the city park. But as time goes by he feels lonesome and wishes to be in company. So he takes his mobile device 1 and enters the mobile community service by advertising his phone with the text message 7 (FIG. 2): “Hello, my name is Peter, I am looking for some company this evening to have some drinks and relaxed chatting”. He decides to receive any message, text, picture, phone call or video message and advertises his device 1 in the whole city region as it is not too late in the afternoon. He decides to become active in the receiving mode at the same time. The message 7 is routed via the mobile communications network 2 to a communication center 3 where it is received and processed. The message is combined with a location information of Peter's mobile device 1 and transmitted via the mobile communications network 2 throughout the city. None of the received “advertisement” messages tracks his interest. But after some minutes a text message comes in, sent by Linda via her mobile device 4, who wants to put up a chat session to get in first contact. After some chatting Linda asks him if he can send a picture. Of course he does and in turn he asks Linda for a phone connection. After having chatted for a while Linda asks him for his preferred food, as she wants to join a vegetarian barbecue party and is looking for company. Peter is enthusiastic about vegetarian barbecue and they decide to meet one hour later to go for grilled cauliflower and roasted carrot.

The communication center, 3 is also connected to the Internet 5 so that the user has the possibility to create content at his home Personal Computer 6 and store it for later selection via the mobile's menu.

### FURTHER ENHANCEMENTS

For fast growing communities and a vast number of members, it could become difficult to decide for an “advertisement”. This can easily be solved by differentiating the advertisements according to contact aims, such as personal contact or conversational contact only. Passing details with the advertisement by sending personal interest such as hobbies or planned activities can be supported by offering an addressable subject field that pops up at the receivers device and gives him the possibility to accept or refuse the session.

### CONCLUSIONS

Packet based mobile networks of 2.5 and 3rd generation are able to provide the capacity and reliability prerequisite to mass roll out of this service that has high potential to become adopted in the life of a considerable percentage of mobile subscribers. At present only IMS based networks are able to handle the features and media components necessary to create this new mobile community service.

1-20. (canceled)

21. An internet protocol based multimedia system using means for location information and media components during information (7) exchange between a communication center (3) and peripheral units (1, 4), wherein the means for location information and the media components are provided by at least a mobile communications network (2.), and the communication center (3) providing a transmission of messages (7) via a mobile community service,
wherein the region in which the message (7) is being distributed is specified by different distribution classes, including the classes “local”, “walking distance” and “city wide”, whereby the distribution class “local” covers approximately the size of a radio cell and / or the neighboring cells, the distribution class “walking distance” covers the region within a walking distance, and the distribution class “city wide” covers a region within the borders of a city.

22. The internet protocol based multimedia system according to claim 21, wherein the information (7) includes at least one of a text message, a voice messages, a picture message or a video message, or a combination thereof.

23. A process for information exchange using components of an Internet protocol based multimedia system according to claim 21, the process comprising the steps of
providing the information exchange including a transmission of messages (7) via a mobile community service, allowing the subscriber to send contact data from his mobile handset. (1) to mobile handsets (4) of other users and vice versa, wherein the messages of a chosen media type are to be sent within a certain range around the subscribers current location or a set of chosen media types are to be received from other users within a certain range, wherein the region in which the message (7) is to be distributed is specified by different distribution classes, including the classes “local”, “walking distance” and “city wide”, whereby the distribution class “local” covers approximately the size of a radio cell and/or the neighboring cells, the distribution class “walking distance” covers, the region within a walking distance, and the distribution class,’ city wide” covers a region in the borders of a city.

24. The process according to claim 23, wherein an application menu is operated in the terminal devices (1, 4) of users of the mobile communication network (2) for gaining access to the mobile community service.

25. The process according to claim 23, wherein the mobile community service comprises an active mode and wherein the subscriber becomes active and sends messages (7) to mobile devices (4) of other users, and wherein the mobile community service comprises an inactive mode in which the subscriber receives other community members messages only.

26. The process according to claim 25, wherein in both modes the preferred name and media type of the messages (7) is specified.

27. The process according to claim 25, wherein in the active mode the user specifies the media type and the special content of the message to be sent to other users.

28. The process according to claim 23, wherein the messages are recorded directly by using the user's mobile terminal capabilities.

29. The process according to claim 23, wherein the messages are chosen from a set of pre-recorded contents.

30. The process according to claim 29, wherein the contents are predefined and stored under a personal account via a web interface.

31. The process according to claim 29, wherein the stored y contents are offered on a selection menu automatically to the subscriber if the active mode is selected.

32. The process according to claim 23, wherein web access to the Internet (5) is provided to all the users.

33. The process according to claim 23, wherein the users create content at a personal computer (6) and store the content for later selection via the mobiles menu, and wherein the pre-recorded content is displayed automatically when the mobile terminal community service module is activated.

34. The process according to claim 23, wherein the user specifies the region in which messages (7) can be sent and/or received.

35. The process according to claim 23, wherein the messages (7) are differentiated according to contact aims.

36. The process according to claim 23, wherein the messages (7) include details of personal interests.
